(19) United States
(12) Patent Application Publication
(10) Pub. No.: US 2008/0301737 A1
(43) Pub. Date: Dec. 4, 2008

(54) SYSTEM AND METHOD FOR PERSONALIZED TELEVISION VIEWING TRIGGERED BY A PORTABLE COMMUNICATION DEVICE

(75) Inventors: Randi-Lise Hjelmeland Almas, Leikanger (NO); Funabashi Yoshimitsu, Malmo (SE); Yamagami Rui, Limhamn (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/755,871

(22) Filed: May 31, 2007

(51) Int. Cl. H04M 1/00; G06F 3/00

(52) U.S. Cl. 725/61; 455/550.1

(57) ABSTRACT

A portable communication device is equipped with a content and/or channel recommendation function that is configured to provide a user with content recommendations for watching a television program. The portable communication device is used as a remote control to control various aspects of the television. In one embodiment, channel recommendations are made based upon the user's mobile activities. Such activities include: web browsing, web searching, multimedia content rendered and/or downloaded on the portable communications device, contact information, and calendar information stored on the portable communication device. In another embodiment, the user may view television programs previously and/or currently being watched by a contact.

### TECHNICAL FIELD OF THE INVENTION

The present invention relates generally to portable communication devices, and, more particularly, to a system and method for viewing multimedia content on a television or other suitable viewing device based at least in part on content stored in a portable communication device.

### DESCRIPTION OF RELATED ART

Portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide features and services beyond voice communications. The wireless industry is experiencing a rapid expansion of mobile data services. In addition, the features associated with certain types of portable communication devices have become increasingly diverse. To name a few examples, many portable communication devices have cameras, text and multimedia messaging capability, Internet browsing functionality, electronic mail capability, video playback capability, audio playback capability, image display capability, position sensing capability and hands-free headset interfaces.

With the rapid expansion of portable communication device functionality, users continue to make use of their portable communication devices for more and more activities, e.g., electronic mail communication, Internet browsing, music and video downloading and playback and the like. With many of these activities, the portable communication device may be configured to accept and store the user's preferences and/or profiles associated with each activity.

### SUMMARY

In view of the foregoing, a need exists for additional mobile data services, and application programs for providing additional mobile data services, such as a personalized television viewing profile application program that facilitates selecting multimedia content displayed on a television or other suitable viewing device based information stored on a user's portable communication device and/or a portable communication device of a contact or other desired member.

One aspect of the technology relates to a portable communication device comprising: a memory; and a controller coupled to the memory, wherein when the controller executes a content recommendation application program stored on a machine-readable medium, wherein when the content recommendation program is loaded in memory and executed causes the portable communication device to: generate one or more channel recommendations based on user activities and/or user preferences involving the portable communication device; and transmit a request to an electronic device through a local interface associated with the portable communication device for displaying the one or more channel recommendations based at least in part on the user activities and/or user preferences to an associated user.

According to another aspect, the memory stores activity information for use by the content recommendation program.

According to another aspect, the activity information includes at least one selected from the group of: Internet browsing history, Internet searching history and/or geographical location of the portable communication device.

According to another aspect, the activity information includes at least one selected from the group of calendar information and/or contact information.

According to another aspect, the local interface is suitable for facilitating infrared communications with the electronic device and/or a coupler device coupled to the electronic device.

According to another aspect, the local interface is suitable for facilitating radio frequency communications with the electronic device.

According to another aspect, the radio frequency communications are compatible with Bluetooth communication signals.

According to another aspect, a keypad is coupled to the controller, wherein the keypad is adapted for receiving user input to select a recommended channel.

According to another aspect, the portable communication device is a mobile telephone.

One aspect of the technology relates to a method of recommending a channel on a television using a portable communication device based on information stored in the portable communication device, the method comprising: logically associating a portable communication device and a television by initiating the logical association by the portable communication device; activating a television by transmitting a signal from a local wireless interface of the portable communication device to the television; generating one or more channel recommendations to television for display on the television, wherein the one or more channel recommendations are based upon activity information stored in the portable communication device; transmitting the one or more channel recommendations to the television for display on the television; and selecting at least one of the one or more channel recommendations.

According to another aspect, the step of logically associating the portable communication device and the television includes storing a unique identifier associated with the television in a memory of the portable communication device.

According to another aspect, the step of logically associating the portable communication device and the television includes storing a unique identifier associated with the television and the mobile telephone in a remote server.

According to another aspect, the step of activating the television includes generating an electrical signal to turn on the television in response to a user action.

According to another aspect, the step of generating one or more channel recommendations is based on activity information that includes at least one selected from the group of: Internet browsing history, Internet searching history and/or geographical location of the portable communication device.

According to another aspect, the step of generating one or more channel recommendations is based on activity information that includes at least one selected from the group of calendar information and/or contact information.

According to another aspect, including displaying contacts associated with the portable communication device on the television.

One aspect of the technology relates to a method of recommending a channel on a television using a portable communication device based on information stored in the portable communication device, the method comprising: requesting content viewed by a contact stored in memory of the portable communication device from a remote server; generating one or more channel recommendations to television for display on the television, wherein the one or more channel recommendations are based upon content viewed by the contact; transmitting the one or more channel recommendations to the television for display on the television by the remote server; and selecting at least one of the one or more channel recommendations.

According to another aspect, the remote server includes a memory for storing content recommendations.

According to another aspect, including logically associating the portable communication device and the television and storing the logical association at the remote server prior to requesting content.

According to another aspect, the step of selecting is performed by transmitting a suitable selection response from the portable communication device to the television.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a portable communication device in accordance with aspects of the technology.

FIG. 2 is a diagrammatic illustration of a portable communication device in accordance with aspects of the technology.

FIG. 3 is a diagrammatic illustration of a communications system including a portable communication device on which aspects of the technology may be carried out;

FIG. 4 is an exemplary database in accordance with aspects of the technology.

FIG. 5 is a flow chart or functional diagram representing a method for generating channel recommendations in accordance with aspects of the technology.

FIG. 6 is a flow chart or functional diagram representing a method of use in accordance with aspects of the technology.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form. The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like. Other exemplary electronic equipment and mobile radio terminals may include, but are not limited to, portable media players, media jukeboxes and similar devices having a radio transceiver.

In the present application, the invention is described primarily in the context of a mobile telephone. However, it will be appreciated that the invention is not intended to be limited to a mobile telephone and can be any type of electronic equipment.

The term “channel” will be used to broadly mean any one of multiple broadcast services that may be received by the electronic equipment. Accordingly, each channel may correspond to a television station or a radio station. Channels may also correspond to a set of programs offered by a television, video, radio, music and/or other content service (e.g., there may be one service provider that offers a number of programs, such as in the form of a play list). As will be appreciated, each channel delivers corresponding audiovisual content. The content may change over the course of time (e.g., a news program may be followed by a sporting event, which is followed by movie).

Audiovisual content may be received in other manners, such as by podcasts, Internet downloads, etc. Accordingly, media content and media content recommendations may relate to any mobile media format or content type including, but not limited to, mobile television, mobile radio, internet radio channels, podcasts, RSS feeds, Internet webpages, video clips, audio clips, audio books, animations, ring tones, commercials and so forth.

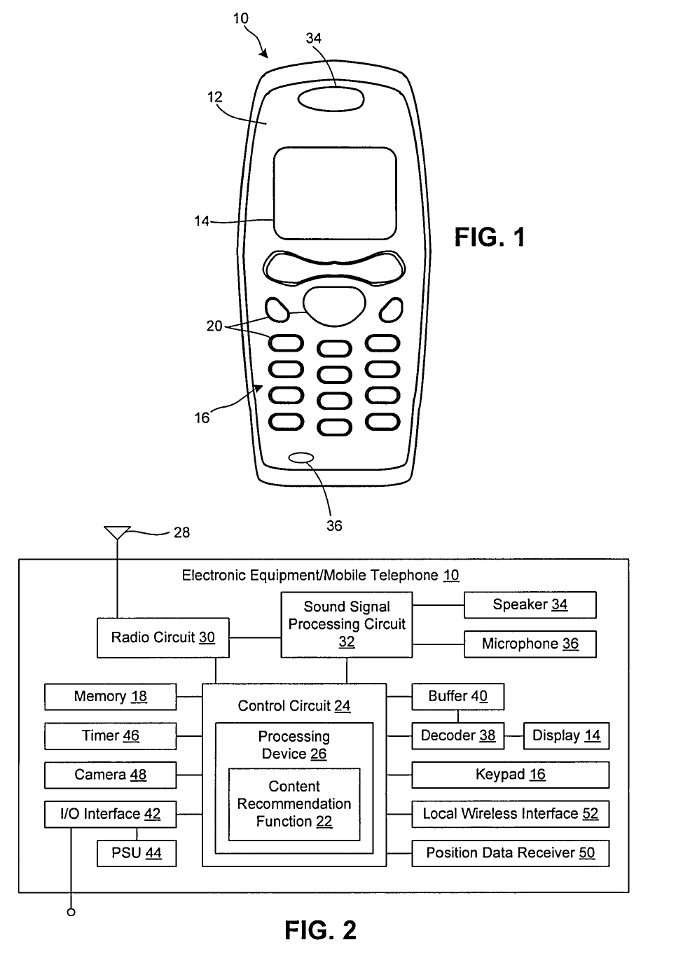

Referring initially to FIG. 1, an electronic equipment 10 is shown in accordance with the present invention. The electronic equipment includes a content and/or channel recommendation function 22 (FIG. 2) that is configured to provide a user with content recommendations. In environments where channels may be delivered through mechanisms other than or in addition to a channel based mechanism, the channel recommendation function may be referred to as a media, multimedia, contact and/or other such recommendation function. It will be appreciated that the channel recommendation function may be embodied as executable code that may be resident in and executed by the electronic equipment 10.

The electronic equipment in the exemplary embodiment is a mobile telephone and will be referred to as the mobile telephone 10. The mobile telephone 10 is shown as having a “brick” or “block” form factor housing 12, but it will be appreciated that other type housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 may include special function keys such as a “call send” key for initiating or answering a call, and a “call end” key for ending or “hanging up” a call, a channel recommendation key, etc.

Special function keys may also include menu navigation keys, for example, for navigating through a menu displayed on the display 14 to select different telephone functions, profiles, settings, etc., as is conventional. Likewise, a special function key and/or any other mechanism may be used to initiate the channel recommendation function 22. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 may include dedicated keys that comprise a portion of the keypad 16 to generate remote control commands for reception by a device to be controlled (e.g., a television, stereo, video player, audio player, etc.). Additionally, conventional mobile telephone keys may be used to generate remote control commands for reception by the device to be controlled. For example, the key or keys on the mobile telephone 10 that control volume on the mobile telephone 10 may also be used to control volume on the device to be controlled. One or more other keys may be used to perform other remote control functions (e.g., changing a channel, selecting an input, selecting a device, etc.).

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of a channel recommendation function 22, which is preferably implemented as executable logic in the form of application software or code within the mobile telephone 10, the construction of the mobile telephone 10 is otherwise generally conventional.

The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out operation of the mobile telephone 10. The memory 18 may be, for example, one or more of a buffer, a flash memory, a hard drive, a removable media, a volatile memory, a non-volatile memory or other suitable device. In addition, the processing device 26 executes code in order to perform the channel recommendation function 22.

It will be apparent to a person having ordinary skill in the art of computer programming, and specifically in applications programming for mobile telephones or other items of electronic equipment, how to program a mobile telephone 10 to operate and carry out the functions described herein. Accordingly, details as to the specific programming code have been left out for sake of brevity. Also, while the channel recommendation function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system, as well as to receive audiovisual content. For example, the receiver may be an IP datacast compatible receiver compatible with a hybrid network structure providing mobile communications and DVB-H based or similar services. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. Optionally, the display 14 may be coupled to the control circuit 24 by a video decoder 38 that converts video data to a video signal used to drive the display 14. The video data may be generated by the control circuit 24, retrieved from a video file that is stored in the memory 18 or derived from an incoming video data stream received by the radio circuit 30. Prior to being fed to the decoder 38, the video data may be buffered in a buffer 40 or other suitable buffering device.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown). Further, the I/O interface(s) 42 may serve to connect the mobile telephone 10 to a personal computer or other device via a data cable. The mobile telephone 10 may receive operating power via the I/O interface(s) 42 when connected to a vehicle power adapter or an electricity outlet power adapter.

The mobile telephone 10 also may include a timer 46 for carrying out timing functions. Such functions may include timing the durations of calls, generating the content of time and date stamps, etc. The mobile telephone 10 may include a camera 48 for taking digital pictures and/or movies. Image and/or video files corresponding to the pictures and/or movies may be stored in the memory 18.

The mobile telephone 10 also may include one or more local wireless interfaces (indicated generally as wireless interface 52), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, a television, a coupler device or any other electronic device. Also, wireless interface 52 may be representative of an interface suitable for communication within a cellular network or other wireless wide-area network (WWAN).

The mobile telephone 10 may be configured to transmit, receive and process data, such as text messages (e.g., a short message service (SMS) formatted message), electronic mail messages, multimedia messages (e.g., a multimedia messaging service (MMS) formatted message), image files, video files, audio files, ring tones, streaming audio, streaming video and so forth. Processing such data may include storing the data in the memory 18, executing applications to allow user interaction with data, displaying video and/or image content associated with the data, broadcasting audio sounds associated with the data and so forth.

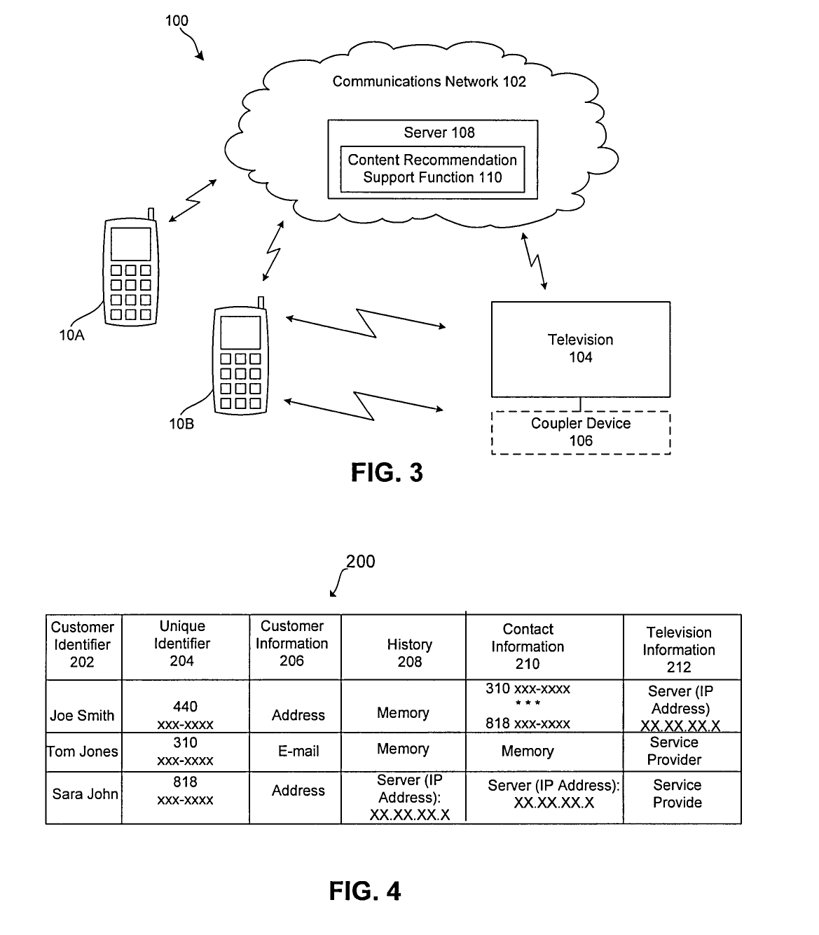

With additional reference to FIG. 3, the mobile telephone 10 may be configured to operate as part of a communications system 100. The system 100 may include one or more of the following components: one or more additional mobile telephones 10 (e.g., mobile telephones 10A and 10B), a communication network 102 and a television 104 and/or an optional coupler device 106. In general, the system 100 allows the various components that have the proper authorization to communicate with each other, as described below. For example, assuming mobile telephone 10B is associated with television 104 or vice versa, the mobile telephone 10B and the television 104 may communicate with each other through the server 108, directly through an infrared interface or other suitable interface (e.g., Bluetooth), and/or through the coupler device 106.

The communications network 102 includes a server 108 (or servers) for managing information. Such information may include calls placed by and destined to the mobile telephones 10A and 10B, transmitting to and receiving data from the mobile telephones 10A and 10B, transmitting to and receiving data from the television 104 and/or optional coupling device 106, exchanging information between the mobile telephones 10A and 10B and television 104, and carrying out any other support functions.

The server 108 may communicate with the mobile telephones 10A and/or 10B via one or more transmission medium. The transmission medium may be any appropriate device or assembly, including, for example, a communications tower, another mobile telephone, a wireless access point, a satellite, etc. Portions of the network may include wireless transmission pathways, as well as wired transmission pathways. The network 102 may support the communications activity of multiple mobile telephones 10A and 10B, as shown in the illustration of FIG. 3.

In one embodiment, the server 108 may operate in stand alone configuration relative to other servers of the network 102 or may be configured to carry out multiple communications network 102 functions. As will be appreciated, the server 108 may be configured as a typical computer system used carry out server functions and may include a processor configured to execute software containing logical instructions that embody the functions of the server 108. Those functions may include functions that are complimentary to the operation of the content recommendation function 22 of the mobile telephone 10, and will be collectively referred to as a content recommendation support function 110.

The server 108 may store information transmitted from one or more of the various components of the systems 100 (e.g., mobile telephones 10A and 10B, television 104, coupler device 106, etc.). In addition, upon request or at predetermined times, the server 108 may download the stored information to one ore more of the various system components.

As shown in FIG. 3, the mobile telephone 10B and the television 104 are communicatively coupled through the shared server 108 and/or through the coupler device 106. As shown, the mobile telephone 10A is not coupled to the server 108 because it has not been associated and/or authorized to receive and/or transmit information through the server 108 and/or the coupling device 106. The mobile telephone 10B may communicate directly with the television 104 using an infrared interface 52 or any other suitable communication interface (e.g., radio frequency, near field communication, etc.). The mobile telephone 10B may also communicate with the coupler device 106 directly through one or more other suitable communication interfaces. Exemplary communication mediums include infrared (IR), Bluetooth, radio frequency (RF), NFC, etc.

The coupler device 106 may be a cable box, a device (e.g., a MW200) that connects portable audio sources (e.g., mobile telephones 10, MP3 players, satellite radios, televisions, etc.) to stereo equipment located in the home, office and/or vehicle. Generally, the coupler device 106 links the television 104 to at least a portion of the network 102.

In order to carry out one or more aspects of the present invention, the mobile telephone 10B may be registered (also referred to above as authorized and/or associated) in the television, by sending an authorization from the television to the mobile telephone, or by sending a request from the mobile telephone to the to television (e.g., through a server 108).

In addition, the television 104 may include an application program that can automatically register mobile telephones within a certain area to initialize television account access to the television from the mobile telephone. For example, the television 104 may utilize a Bluetooth communication protocol to identify authorized devices within communication distance to the television. For the initial connection, a user account may be set up manually on the television, where the user is provided the opportunity to identify favorite channels, favorite television programs, etc., using the mobile telephone 10 as a remote control. This information may be stored on the television 104, at the server 108 and/or on the mobile telephone 10, thereby making the information available to the user each time the user logs into his or her television. Also, the television 104 may register the user's viewing history in the user's telephone 10 and/or the server 108.

As stated above, the television 104 and the mobile telephone 10 may be communicatively coupled through the shared server 108. Generally, the server 108 maintains a channel recommendation support function 110. Referring to FIG. 4, the channel recommendation support function (CRSF) 110 may include an exemplary database 200 that includes a plurality of fields to support content recommendation among user's and associated contacts. The exemplary database 200 includes a customer identifier 202, a unique identifier 204 associated with the customer, customer information 206 (e.g., address, billing information, etc.), a history of user activities 208, contact information 210 for contacts stored in the memory of the mobile telephone 10 (e.g., electronic phonebook application), etc. In addition, a television information field 212 is included, which provides a link between the mobile telephone 10 and the user's television 104.

The database 200 may track any desired information associated with the user and/or the user's contacts. Exemplary tracked information includes, for example, contacts, web pages viewed, multimedia rendered by the mobile telephone 10, multimedia rendered by the contact's mobile telephone, history, etc. Generally multiple columns and/or rows of information may be desired to maintain and/or otherwise monitor the database 200. In addition, the content stored in the database may any desired form. For example, the contents for a column may in the form of text, numbers, IP addresses, network information, linked lists, uniform resource locators (URL) links to additional information, databases or any other suitable information.

As shown in FIG. 4, information associated with three customers in the database 200 is illustrated. Each of the customers have a customer name 202 (e.g., Joe Smith, Tom Jones and Sara John), a unique identifier 204 (e.g., 440 xxx-xxxx, 310 xxx-xxxx and 818 xxx-xxxx), which may be a telephone number or other unique identifier, and customer information 206 (e.g., address, billing information, e-mail address, etc.). The mentioned fields contain values that may be directly read from the database. One of ordinary skill in the art will readily appreciate that the fields also may be populated entries that require the application to visit one or more additional other programs, applications, databases, servers, networks etc to obtain the desired information. For example, history field 208, contact field 210 and television field 212 may refer to information contained on a remote server, embedded in another customer field, embedded on a remote network, stored locally in memory of the mobile telephone, etc. For example, the history information 208 may be stored in memory of the mobile telephone 10 or remotely on a server and/or network. Likewise, the contact information 210 may be stored in memory of the mobile telephone 10, in an electronic phonebook and/or remotely on a server. The television field 112 may include an IP address associated with the user's television or television service provider. One of ordinary skill in the art will readily appreciate that these examples are exemplary in nature and in no way intended to limit scope of the present invention.

The database 200 generally is capable of storing information allowing the user to view multimedia channels based on preferences determined from the user's mobile telephone habits and/or habits of the user's contacts.

The channel recommendation function 22 may include one or more of the fields provided in the database 200. Generally, the channel recommendation function 22 may include one or more profiles for various users of the mobile telephone (e.g., customer identifier 202).

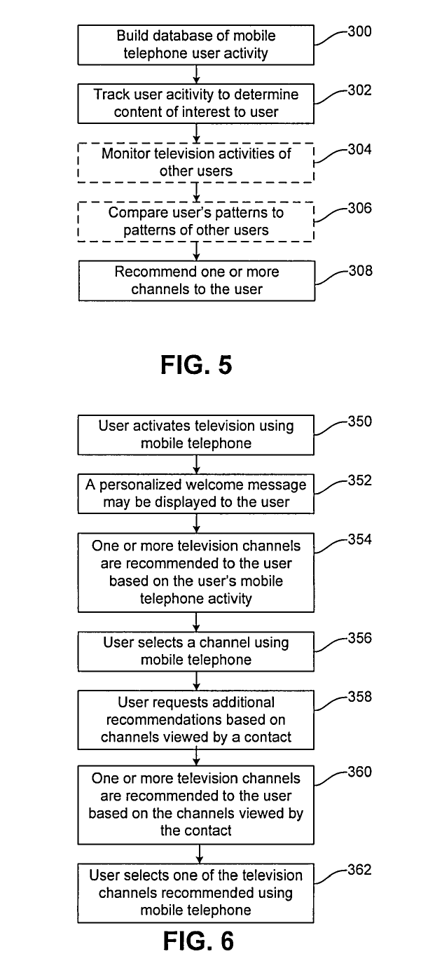

Referring to FIG. 5, a method of recommending media content to a user of the mobile telephone 10 is depicted. The exemplary method of FIG. 5 describes the recommendation of mobile television channels to the user. It will be appreciated that the method may be adapted to recommend radio stations and/or other forms of content delivery, such as podcasts, to the user. Therefore, while the description herein refers to the recommendation of television programming to the user, the invention is not limited a single type of media or content delivery mechanism. Portions of the functionality of the method may be carried out by the mobile telephone 10 and portions of the functionality of the method may be carried out by the server 108. For example, the functionality of the method may be embodied as executable code, such as in the form of the channel recommendation function 22 and/or the channel recommendation support function 110, or any other suitable form, including software, firmware, dedicated circuit components, a program stored on a computer readable media or in machine usable medium, and so forth.

Although the illustrated method shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 300 where a database of a mobile telephone user's activity is established. The history may include all user's subscribing to a mobile telephone service offered by an operator of the communications network (e.g., mobile telephone network provider, cable television, satellite television, etc.). In another embodiment, the users for block 300 may be a select group of users and/or users who have agreed to have their history activity monitored for construction of the database. In one embodiment, the functions of block 300 may be carried out by the channel recommendation support function 110 executed by the server 108. When the method is adapted to provide media content recommendations for media other than or in addition to television channels, the users may be referred to as media or content consumers and the monitoring of viewing patterns may be referred to as monitoring content selection behavior.

In block 302, individual and/or group user activity is monitored to find patterns in all media viewed and/or otherwise accessed by the user. For example, Internet activity, search activity, multimedia content downloaded, multimedia content accessed, multimedia content rendered by the mobile telephone, channels and/or the type of content that users tend to have an interest. For example, certain users who often choose to watch a particular channel dedicated to sports or access sports information on their mobile telephone may also watch television channels dedicated to sports. As another example, by observing behavior and identifying patterns, it may be found that viewers who watch movies on a regular basis may also watch channels dedicated to fashion and celebrity news. As another example, viewers who watch one news service may also watch a second news service, but not a third news service.

The database generation may include observing user patterns based on user demographics. For example, categories of viewers by age, gender, race, nationality and so forth may be established as part of the database so that user patterns by demographic group may be established. The database generation may include observing user history patterns based on market segmentation (including one or more parameter such as psychographics, geographic (viewer location), language, etc.), connection type and/or device type. Tracking market segmentation may enable the establishment of user viewing patterns by market segment. Tracking connection type and/or device type may assist in making content recommendations for which the user's device can receive and/or play back.

Of course, observing user behavior and identifying patterns in the channels and/or content selected by viewers can be carried out in a number of different ways. Exemplary techniques are described herein, but other techniques and/or modifications to the described techniques are possible and are considered to be suitable techniques. The channel recommendation support function 110 may rely on only one technique to build the database or plural techniques to build the database. Also, multiple techniques may be combined by merging the processes.

An example technique for determining patterns of interest is to monitor the content that the users have a propensity to make. For example, monitoring of user behavior may reveal that a viewer or viewers have a pattern (e.g., “modus operandi”) when making channel selection, such as selecting from only a few channels from a larger number of available channels when attempting to find content of interest. Monitoring may reveal that channels tend to be selected based on types of offered content, in a particular order and/or with a particular frequency. Other observable behavior may include observing the types of channel selections that the users make based on the time of day and/or day of the week. As will be appreciated, various additional and/or alternative statistical analysis techniques may be used to assess user behavior.

In one embodiment, the particular channels of most interest to a user are determined and used to generate a “favorites” style channel selection list on a user by user basis. The data for each user may be statistically combined to generate viewing patterns. In a variant technique, the users may personally define a list of their favorite channels to view. Different lists may be generated for different times of day, different days of the week and/or different contacts.

Another example data collection technique may involve monitoring the popularity of a channel, such as by using Nielson ratings, the accumulated view time of each available channel, the number of users who watch a channel, the number of the user's contacts that that watches a channel and so forth. Monitoring accumulated view time and/or accumulated frequency with which users have historically selected each available channel for viewing may reveal that viewers tend to watch certain channels over other channels. For instance, based on one or more of these parameters, a score or percentage value may be associated with each channel. Static rating may be used to rank each channel according to overall viewership across all time slots. Dynamic ratings may be used to rank each channel according to viewership at the particular time to take into consideration the popularity of content aired at particular times. Therefore, dynamic ratings would rank the most popular channel for the particular time ahead of other channels, even if that channel is not as popular at other times.

Data collection may include a content based metric. This technique is used to observe the particular programming or a particular type of content that the user views often or with regularity. For example, it is possible to monitor for viewer selection of recurring television shows (or program series), Internet browsing history, etc. Thus, this metric is based on type of content and monitored behavior. Categories of regularly watched content and how often or frequently each are watched may be developed. An example set of categories could include sporting events in general, particular types of sports (e.g., football/soccer, American football, basketball, etc.), particular sporting teams, news programs in general, particular types of news programs (e.g., national news, local news, business and financial news, etc.), cooking shows, music videos, and so forth.

As indicated, the techniques to establish history patterns may be based on monitored viewer behavior, time of day and/or day of the week, user demographics, market segmentation, connection type, device type, etc. Aspects from one or more techniques may be merged with or integrated in another technique. Accordingly, each technique should be considered combinable with every other technique. Aspects of each technique may be tuned over time to improve accuracy of the pattern recognition.

From the monitoring of user behavior, patterns may be identified to find common viewing habits among groups of users. Using the assumption that a user who has overlapping viewing habits as a group of viewers may enjoy watching content selected by others in that group, the method may establish viewing recommendations for the user as explained in greater detail below.

With continued reference to FIG. 5, optionally at block 304, the viewing patterns of the other users (e.g., other network users, the user's contacts, etc.) may be monitored and ascertained. The monitoring may be made as part of the monitoring made in block 302, on an individual and/or group basis. As such, any one or combination of behavior monitoring techniques described above may be employed for monitoring the user's behavior and establishing viewing tendencies of the user. The monitoring may be carried out by the channel recommendation function 22 resident in the mobile telephone 10 and/or by the channel recommendation support function 110 of the server 108. If the monitoring is carried out in the mobile telephone 10, results of the monitoring may be transmitted to the server 108 for use in developing the database of content selection patterns and/or to match user behavior (e.g., in the form of a content selection pattern) with the content selection patterns of others.

Resulting from block 304 may be an assessment of the user's viewing behavior. For example, the channels selected by the user and/or the type of content selected by the user may be determined. The viewing behavior may be determined for individual time slots. From the assessment, the types of channels and/or content that the user most often views may be determined. The types of channels and/or content may be categorized using the categories of channels and/or content into which the habits of multiple viewers are categorized in block 300. Example categories include sports and types of sports programming, news and types of news programming, drama shows, comedy shows, detective shows, animated shows, music videos, reality shows, and so forth.

Optionally, the method proceeds to block 306 to compare the user's patterns to patterns of others. In cases, where the user is not interested in the viewing patterns of others, the method proceeds to block 308.

Proceeding to optional block 306, the channel recommendation function 22 and/or the channel recommendation support function 110 may compare the user's viewing pattern determined in block 302 to the patterns of contacts and/or plural users established in block 304. The comparison may establish matches between the user's behavior and that of others. The comparison may include comparing the user's history statistics with the history statistics of the other viewers in general or the history statistics of other users having a similar demographic profile, market segment profile, connection type and/or device type as the user. From matches between the user's behavior and that of other users, channels and/or content that is not watched at all by the user or not regularly watched by the user, but that may be of interest the user, may be ascertained. For example, it may be determined that the user regularly watches CNN news and that others who watch CNN news also watch BBC news or it may be determined that BBC news may be an alternative to CNN news in markets where CNN news is not available.

The matching can use data regarding what the user has selected to watch, search for or otherwise access in the past and mapping those selections to selections of others. The mapping may be made on the basis of channel and/or content. For example, if the user watches sports and cooking channels/shows, the matching algorithm may search for the viewing habits of others who demonstrate a propensity to watch sports and cooking channels/shows. This may reveal that a certain dramatic program is popular among these individuals or that a particular news channel is popular among these individuals. In one embodiment, the building of the database in block 302 places each content choice of all the monitored viewers into a category from a predetermined set of categories. Using statistical analysis of the categorized viewing habits, content selection patterns for subgroups of viewers may be ascertained. Each content selection pattern may be indicative of one or more categories frequently selected by a subgroup of the monitored viewers. Using the frequency with which the user selects channels and/or content from certain categories, a match may be made to one or more of the content selection patterns.

Proceeding to block 308, the channel recommendation function 22 and/or the channel recommendation support function 110 may recommend channels of interest to the user. The recommending of block 308 may include transmitting a recommendation from the server 108 to the mobile telephone 10 and/or displaying the recommendation on the display 14 of the mobile telephone. The channel recommendation function 22 may also transmit a recommendation for display on the television directly through the appropriate local interface to the television 104 and/or coupler device 106.

The recommendation may be made on a general basis or based on content available at a certain time. Since the recommendation may be based on statistical data derived from the user's behavior and the behavior of others, it is contemplated that the recommended channel and/or content will contain a selection that the user may enjoy viewing. A recommendation may be phrased to draw a connection with a channel or content known to be viewed by the user. An example viewing suggestion may be: “since you like to listen to Madonna, you might like to watch a television program about Madonna on channel X, which starts in a few minutes”. In another example, a recommendation about a traveling program on Riga may be provided to the user based on the user's Internet browsing (e.g., when the user searched for Riga). In another embodiment, a channel recommendation may be made to the user based on the user's calendar (e.g., an entry in the calendar states that “football training begins today”, a recommendation for a football game is presented to the user). In another embodiment, a channel recommendation may be made to the user based on the user's daily travel (e.g., a recommendation based upon a company in your travel area is made based upon the detected travel of the user and/or a meeting appointment made in the user's calendar).

It is contemplated that the recommendations may assist the user choose from an extensive supply of mobile television channels, or, more generally, content from multiple content choices. In addition, the recommendations may assist the user choose a channel when traveling to a location where the user is unfamiliar with the available channels. Thus, the recommendations may function as an intelligent television guide (or, more generally, an intelligent media guide). Recommendations may be offered to the user at selected times. Example times to present recommendations may be when launching a mobile television viewing program, switching channels, at the end of broadcast (e.g., to suggest what the user may wish to view next), at the time a broadcast is starting (e.g., to suggest an alternative to what the user may be currently watching) and so forth.

Recommendations may be made upon user request. For example, the user may de-press a key that activates the channel recommendation function 22. The user may request channels and/or shows that may be of interest to the user for a certain date and time. Other requests may be formatted to request channels and/or shows within a particular category (e.g., sports, dramas, movies, news, etc.) that may be of interest to the user.

An exemplary method of use in accordance with the invention is illustrated in FIG. 6. It is assumed for purposes of this method that the user's mobile telephone 10 and television 104 and/or coupler device 106 are logically associated. At block 350, a user activates and/or controls the user's television set 104 using a mobile telephone 10. At block 352, a personalized welcome message is displayed on the television (e.g., “Welcome home, Peter” (assuming the register user's name is Peter). The television 104 may display a listing of the user's favorite television programs and/or a listing of contacts to enable the user to chat (instant messaging) with one or more contacts through the mobile telephone on the television.

One of ordinary skill in the art that when the instant message application is executed (e.g., by turning on the television with the mobile telephone 10), the messaging client attempts to connect to the messaging server. The messaging server (e.g., server 108) verifies the username and password and logs the client on. Once the client is logged on, the client sends the server its IP address, the port number that's been assigned to the IM service and the names of everyone on the user's contact list. The server creates a temporary session file that contains the connection information and checks to see who on the contact list is also logged on. When the server finds contacts that are logged on, it sends a message back to the requesting client with their connection information and sends connection information to the contacts. As soon as all the connection information has been sent and acknowledged, instant messaging can begin.

At block 354, one or more television channels (e.g., programs) are recommended to the user based at least in part on the user's mobile telephone activity. The recommendation may be based on a variety of features (e.g., based on the user's Internet browsing history, Internet searching, the user's calendar, the user's contacts, the user's location, places traveled, multimedia content rendered, multimedia content downloaded, etc.). Block 354 may include accessing the channel recommendation support function 110 located at the server 108. Generally, the recommendations are presented to the user on the television 104.

At block 356, the user selects one of the television channels using the mobile telephone. The user signifies its request by pressing a key on the key pad 16 or any other desired mechanisms.

At block 358, the user may desire to request additional recommendations based on one of the user's contacts. Again, the user signifies its request through a key on the key pad 16 or any other desired mechanisms. A request for information is sent to the server 108. Server 108 determines what the selected contact is currently watching, what the contact has watched over a period of time and the contacts favorite channels and transmits the information to the television 104 directly and/or through the coupler device 106, which then routes information to the television 104. At block 360, one or more television channels are recommended to the user based on the channels viewed by the contact. At block 362, the user selects one of the options received from the server 108 (e.g., select the television channel that the contact is currently watching).

The above example is exemplary in nature and not intended to limit the scope of the present invention. One of ordinary skill will readily appreciate that other functions and/or operations are available based upon the above disclosure. For example, the user may use may invite one or more contacts to chat (through instant messaging or other suitable application) using the user's mobile telephone 10. The chat session may be shown on the television 104 and/or mobile telephone based on the user's preferences.

In addition, the user may also transmit “orders” through the user's mobile telephone 10 to the television 104 through the server 108. An exemplary “order” includes requesting the server to search for channels having a certain type of programming. For example, after a difficult day at work, the user may desire to watch a channel that will make the user laugh. Accordingly, when the user is on his or her way home from work, a request is made to the server to queue comedy channels on the television for viewing when the user gets home. When the user gets home and turns on the television with his mobile telephone, the television will have comedy recommendations available to the user based on the order message.

The mobile telephone may also be used to modify the look of the menu on the television. For instance, a theme on the user's mobile telephone may also shown the user's television, which provides a more personal experience on the television than currently available and provided a more seamless experience between the user's mobile telephone and television.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a memory; and
a controller coupled to the memory, wherein when the controller executes a content recommendation application program stored on a machine-readable medium, wherein when the content recommendation program is loaded in memory and executed causes the portable communication device to:
generate one or more channel recommendations based on user activities and/or user preferences involving the portable communication device; and
transmit a request to an electronic device through a local interface associated with the portable communication device for displaying the one or more channel recommendations based at least in part on the user activities and/or user preferences to an associated user.

2. The portable communication device of claim 1, wherein the memory stores activity information for use by the content recommendation program.

3. The portable communication device of claim 2, wherein the activity information includes at least one selected from the group of: Internet browsing history, Internet searching history and/or geographical location of the portable communication device.

4. The portable communication device of claim 2, wherein the activity information includes at least one selected from the group of calendar information and/or contact information.

5. The portable communication device of claim 1, wherein the local interface is suitable for facilitating infrared communications with the electronic device and/or a coupler device coupled to the electronic device.

6. The portable communication device of claim 1, wherein the local interface is suitable for facilitating radio frequency communications with the another electronic device.

7. The portable communication device of claim 6, wherein the radio frequency communications are compatible with Bluetooth communication signals.

8. The portable communication device of claim 1, wherein a keypad is coupled to the controller, wherein the keypad is adapted for receiving user input to select a recommended channel.

9. The portable communication device according to claim 1, wherein the portable communication device is a mobile telephone.

10. A method of recommending a channel on a television using a portable communication device based on information stored in the portable communication device, the method comprising:
logically associating a portable communication device and a television by initiating the logical association by the portable communication device;
activating a television by transmitting a signal from a local wireless interface of the portable communication device to the television;
generating one or more channel recommendations to television for display on the television, wherein the one or more channel recommendations are based upon activity information stored in the portable communication device;
transmitting the one or more channel recommendations to the television for display on the television; and
selecting at least one of the one or more channel recommendations.

11. The method of claim 10, wherein the step of logically associating the portable communication device and the television includes storing a unique identifier associated with the television in a memory of the portable communication device.

12. The method of claim 10, wherein the step of logically associating the portable communication device and the television includes storing a unique identifier associated with the television and the mobile telephone in a remote server.

13. The method of claim 10, wherein the step of activating the television includes generating an electrical signal to turn on the television in response to a user action.

14. The method of claim 10, wherein the step of generating one or more channel recommendations is based on activity information that includes at least one selected from the group of: Internet browsing history, Internet searching history and/or geographical location of the portable communication device.

15. The method of claim 10, wherein the step of generating one or more channel recommendations is based on activity information that includes at least one selected from the group of calendar information and/or contact information.

16. The method of claim 10 further including displaying contacts associated with the portable communication device on the television.

17. A method of recommending a channel on a television using a portable communication device based on information stored in the portable communication device, the method comprising:
requesting content viewed by a contact stored in memory of the portable communication device from a remote server;
generating one or more channel recommendations to television for display on the television, wherein the one or more channel recommendations are based upon content viewed by the contact;
transmitting the one or more channel recommendations to the television for display on the television by the remote server; and
selecting at least one of the one or more channel recommendations.

18. The method of claim 17, wherein the remote server includes a memory for storing content recommendations.

19. The method of claim 17 further including logically associating the portable communication device and the television and storing the logical association at the remote server prior to requesting content.

20. The method of claim 17, wherein the step of selecting is performed by transmitting a suitable selection response from the portable communication device to the television.
